(19) United States
(12) Patent Application Publication
(10) Pub. No.: US 2021/0287217 A1
(43) Pub. Date: Sep. 16, 2021

(54) METHOD AND SYSTEM FOR SECURE REAL-TIME PROCESSING OF AN INVOICE PERTAINING TO A TRANSACTION

(71) Applicant: Ramakrishna GADDIPATI, Bangalore (IN)

(72) Inventor: Ramakrishna GADDIPATI, Bangalore (IN)

(21) Appl. No.: 17/260,983

(22) PCT Filed: Aug. 14, 2018
(86) PCT No.: PCT/IB2018/056100

§ 371 Date: Jan. 15, 2021

(30) Foreign Application Priority Data
Jun. 13, 2018 (IN) 201841022188

(51) Int. Cl. G06Q 20/40; G06Q 20/20; G06Q 30/04

(52) U.S. Cl. CPC G06Q 20/405; G06Q 30/04; G06Q 20/207

(57) ABSTRACT

The invention provides a method and system for performing secure real-time processing of an invoice pertaining to a transaction between a merchant and a client. Upon receiving the invoice, the method and system determines if the invoice includes a merchant's tax registration number and a client's tax registration number. The method and system verifies the invoice by validating the merchant's tax registration number and the client's tax registration number by performing a lookup in a tax registration number database. Additionally, the method and system evaluates and verifies if one or more product/service categories corresponding to line items included in the invoice are in compliance with product/service category policies defined by the client and a line amount is within a spend limit, by checking a rules/policy database. Thereafter, the method and system approves a transaction amount for the transaction in response to verifying the invoice and processes the transaction amount.

### FIELD OF THE INVENTION

The invention generally relates to secure real-time processing of an invoice pertaining to a transaction between a merchant and a client. More specifically, the invention relates to secure real-time processing of an invoice pertaining to a transaction between a merchant and a client, by validating tax registration numbers pertaining to the merchant and the client provided in the invoice, thereby approving a transaction amount for the transaction.

### BACKGROUND OF THE INVENTION

With rapid growth in the field of telecommunications, companies have engineered predominant banking and payment processing solutions on electronic devices that include validating the transactions and authorizing the transactions for receiving payments via financial institutions such as banks. Existing payment processing solutions perform processing of payments based on invoice data, purchase order data, and vendor data and verify a transaction by matching a dynamic data set of client-specified multi-dimensional criteria to captured data for transmitting or denying payment of invoice.

Goods and Services Tax (GST) is a destination based tax, wherein an end user consuming any goods or services is liable to pay the GST. The tax is then received by the State in which the goods or services are consumed. India being a federal country, both the Centre and the States have been assigned the powers to levy and collect taxes (GST). GST is categorized into Central Goods and Services Tax (CGST), State Goods and Services Tax (SGST) or Integrated Goods and Services Tax (IGST) depending on whether the transaction is Intra-State or Inter-State. CGST is a tax levied on Intra State supplies of both goods and services by the Central Government and SGST is a tax levied on Intra State supplies of both goods and services by the State Government. IGST is a tax levied on all Inter-State supplies of goods and/or services.

In current state of the art transaction payment systems, for validating a transaction, the merchant data of a payment request includes tax or merchant registration details (for example, tax number or business number such as a VAT (value added tax) identification number or a registration number) for GST purposes to claim input tax credits, and/or indication of whether the purchase is an online or physical retail location purchase.

However, current solutions available to ensure proper tax treatment on invoices process paper invoices manually. Such a process has many drawbacks including personnel cost, the potential for human error, the lack of tax treatment knowledge for various jurisdictions, increased risk of non-compliance of tax registration number of a client, hard copy invoice storage cost, thus leading to considerable delays in real-time processing of invoices. Further, these solutions do not have means for considering a client's tax registration details for validating the transaction in real-time.

Therefore, in light of the above, there exists a need for an automated method and system for securely processing invoices by validating the invoices based on checking compliance of tax registration numbers (and the tax rates therein) of both the merchant and the client provided in the invoice, thereby enabling faster and a more secure way of processing transaction amounts associated with an invoice of the transaction.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a system for performing secure real-time processing of an invoice pertaining to a transaction between a merchant and a client in accordance with an embodiment of the invention.

FIG. 2 illustrates a payment authorization system for performing secure real-time processing of an invoice pertaining to a transaction between a merchant and a client in accordance with an embodiment of the invention.

FIG. 3 illustrates a flowchart of a method for performing secure real-time processing of an invoice pertaining to a transaction between a merchant and a client in accordance with an embodiment of the invention.

FIG. 4 illustrates a flowchart of a method for determining if the invoice includes a merchant's tax registration number and a client's tax registration number in accordance with an embodiment of the invention.

FIG. 5 illustrates a flowchart of a method for approving a transaction amount for the transaction in response to verifying the invoice in accordance with an embodiment of the invention.

FIG. 6 illustrates a flowchart of a method for approving a transaction amount for the transaction in response to verifying the invoice in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and system components related to secure real-time processing of an invoice pertaining to a transaction between a merchant and a client, by validating tax registration numbers pertaining to the merchant and the client provided in the invoice, thereby approving a transaction amount for the transaction.

Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Various embodiments of the invention provide a method and system for performing secure real-time processing of an invoice pertaining to a transaction between a merchant and a client. Upon receiving the invoice, the method and system determines if the invoice includes a merchant's tax registration number and a client's tax registration number. In response to determining the presence of the merchant's tax registration number and the client's tax registration number in the invoice, the method and system verifies the invoice by validating the merchant's tax registration number and the client's tax registration number by performing a lookup in a tax registration number database. Once the merchant's tax registration number and the client's tax registration number are validated, the method and system identifies one or more product/service categories pertaining to each line item included in the invoice and evaluates if each of the product/service category is in compliance with a product/service category policy defined by the client, by performing a lookup in a rules/policy database. Further, the method and system verifies if a line amount corresponding to a specific product/service category is within a spend limit as defined by the client for the product/service category. In response to verifying the invoice, the method and system approves a transaction amount for the transaction and processes the transaction amount. The approved transaction amount approved may be an invoice amount associated with the invoice or a part of the invoice amount based on the product/service category and spend limits/thresholds.

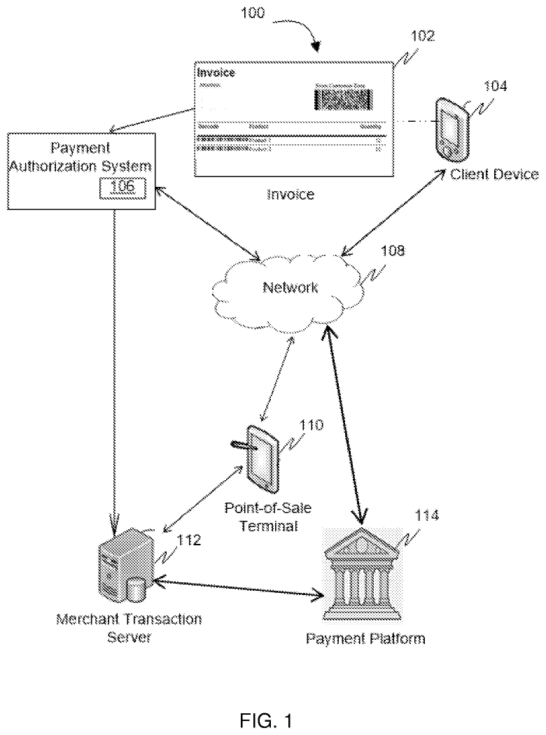

FIG. 1 illustrates a system 100 for performing secure real-time processing of an invoice 102 pertaining to a transaction between a merchant and a client in accordance with an embodiment of the invention.

Invoice 102 may either be in the form of a hard copy or a digital copy that is transmitted to a client device 104. A digital copy can be, but need not be limited to, a word file, an image of invoice 102, and a Portable Document Format (PDF).

Invoice 102 includes a set of data that includes one or more merchant details, client details and transaction details. The merchant details include, but need not be limited to, a merchant name, address and merchant's tax registration number. The client details include, but need not be limited to, a client name, address and client's tax registration number. The transaction details include one or more of, but not limited to, a product/service associated with the transaction, the product/service category, a tax code/rate associated with the product/service category and a transaction amount. The tax registration number can be, but need not be limited to, a Good and Services Tax Identification Number (GSTIN).

The set of data may be encoded in invoice 102 in the form of scannable elements such as, but not limited to, optical machine-readable images (OMRI), bar codes, dataglyphs, graphical elements and various other symbologies.

Client device 104 can be, but need not be limited to, a mobile device, a cellular phone, a smart phone, a tablet computer, a desktop computer, a laptop and a personal digital assistant (PDA).

As illustrated in FIG. 1, client device 104 receives invoice 102 pertaining to the transaction, from the merchant. Upon receiving invoice 102 at client device 104, client device 104 electronically transmits invoice 102 to a payment authorization system 106 over a network 108. Network 108 can be one or more networks, such as, but not limited to, the Internet, an extranet, and/or an intranet, a wired or wireless network. Further, network 108 messages may be communicated with other entities of system 100 via short range wireless communication protocols such as, but not limited to, Bluetooth™, infrared (IR), radio frequency (RF), near field communication (NFC) and/or by long range communication protocols (for example, HTTP, HTTPS), in view of the type of electronic communication required between any device and system 100.

Upon receiving invoice 102, payment authorization system 106 processes invoice 102 by validating the merchant's and client's tax registration numbers included in invoice 102. Payment authorization system 106, then, either authorizes or declines the transaction associated with invoice 102 because of the validation.

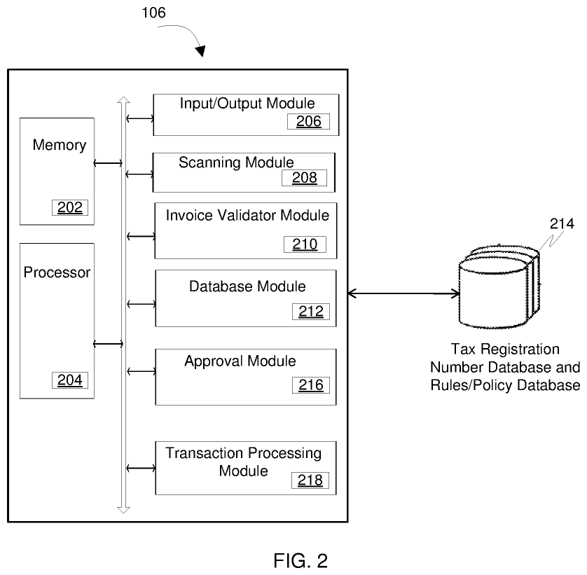

Various modules of payment authorization system 106 are further described in detail in conjunction with FIG. 2.

When payment authorization system 106 authorizes the transaction, a confirmation is sent to client device 104. Further, payment authorization system 106 approves a transaction amount for the transaction based on preset rules and thresholds. Client device 104 may then initiate payment associated with the approved transaction amount at a point-of-sale (POS) terminal 110 using network 108. POS terminal 110, via network 108, communicates with a merchant transaction server 112.

In an embodiment, payment authorization system 106 communicates the approval or authorization of the payment transaction directly to merchant transaction server 108 using an Application Programming Interface (API).

Merchant transaction server 112 processes and completes the transaction by transmitting a funds transfer request to a payment platform 114. Payment platform 114 can be, but need not be limited to, a credit card company, bank or other financial institution. Upon receiving approval of the funds transfer request from payment platform 114, a confirmation of the approval of the funds transfer request is sent to the merchant.

FIG. 2 illustrates various modules of payment authorization system 106 for performing secure real-time processing of invoice 102 pertaining to a transaction between the merchant and the client in accordance with an embodiment of the invention.

As illustrated in FIG. 2, payment authorization system 106 includes a memory 202 and a processor 204 communicatively coupled to memory 202.

Payment authorization system 106 includes an input/output module 206 communicatively coupled to memory 202 and processor 204 for receiving invoice 102.

Payment authorization system 106 further includes a scanning module 208 that is communicatively coupled to memory 202 and processor 204. Scanning module 208 may utilize technologies such as, but not limited to, Optical Machine Readers, Bar Code Readers and Optical Character Recognition (OCR) to scan invoice 102 to extract various parameters from invoice 102. The various parameters extracted from invoice 102 can be, but need not be limited to, a merchant name, address, merchant's tax registration number, a client name, address, client's tax registration number, one or more of a product/service associated with the transaction, the product/service category, a tax code/rate associated with the product/service category and a transaction amount. The tax code/rate pertains to at least one of the categories of GST namely, CGST, SGST and IGST.

Payment authorization system 106 further includes an invoice validator module 210 for validating the various parameters extracted from invoice 102 by scanning module 208. Invoice validator module 210 is communicatively coupled to memory 202 and processor 204. Firstly, invoice validator module 210 determines if invoice 102 includes a merchant's tax registration number and a client's tax registration number by verifying the parameters extracted from invoice 102 by scanning module 208. In response to determining that the merchant's tax registration number and the client's tax registration number are present in invoice 102, invoice validator module 210 verifies invoice 102 by validating both the merchant's tax registration number and the client's tax registration number using a database module 212.

Database module 212 is communicatively coupled to memory 202 and processor 204. Database module 212 is in communication with a Tax Registration Number Database and Rules/Policy Database 214 which includes a tax registration number database and a rules/policy database. The tax registration number database maintains a record of tax registration numbers corresponding to various merchants and clients. On the other hand, the rules/policy database stores a set of validation rules set by clients or users and merchants and policies defined by other regulatory bodies. Validation rules include, but need not be limited to, tax rates, exchange rates, country code indicators (that is, the purchaser and seller tax jurisdictions), transaction amount validation thresholds (for example, spending limits based on transaction type), partial amount transaction thresholds, country local currency codes, legal article numbers, and valid reasons for zero VAT.

Invoice validator module 210 validates the merchant's tax registration number and the client's tax registration number by performing a lookup in the tax registration number database.

Invoice validator module 210 then communicates the result of the validation to an approval module 216. Approval module 216 either approves or declines the transaction pertaining to invoice 102 based on the result of the validation. In an embodiment, approval module 216 approves or authorizes a transaction amount, in response to the validation, for further processing by transaction processing module 218. The transaction amount is either an invoice amount associated with invoice 102 or a portion of the invoice amount, determined based on preset thresholds/limits that are stored in the rules/policy database.

In some embodiments, approval module 216 may further evaluate if each of the product/service category pertaining to each line item included in invoice 102 is in compliance with a product/service category policy as defined by the client. For example, the product/service categories can be a type of service such as, but not limited to, business, entertainment (restaurants, theatres) and a type of product such as, but not limited to, grocery, household items/goods, apparel/footwear, appliances. To perform the evaluation, scanning module 208 reads and extracts each line item from invoice 102 and determines a product/service category corresponding to each line item included in invoice 102.

Approval module 216 then evaluates or verifies if each product/service category included in invoice 102 is in compliance with a product/service category policy as defined by the client, by performing a lookup in the rules/policy database.

Further, approval module 216 determines if a line amount corresponding to a product service category is within a spend limit as defined by the client for the product/service category by checking the rules/policy database.

The client may have defined one or more preset spending limits (or thresholds) for a product/service category pertaining to a line item, say, for instance, grocery. The preset spending limit may be a portion or set amount of the overall total account balance in the main account of the client.

The preset spending limit (or threshold) may also be defined as a per purchase transaction limit/threshold for a specified time such as, but not limited to, per day, per week, per month, per annum. For example, consider that the preset spending limit for household items is set at $100 a month. If the invoice transaction amount is $75 for a first transaction at a grocery store and $60 for a second transaction at another grocery store, approval module 216 authorizes the payment for the first transaction and declines payment of the second transaction as the transaction amount had exceeded the preset spending limit for the second transaction.

In an exemplary embodiment, considering there are multiple line items in invoice 102, scanning module 208 scans each line item and approval module 216 determines one or more product/service categories corresponding to each line item. Approval module 216, then, evaluates if each of the product/service categories are in compliance with a product/service category policy and further evaluates if a line amount provided in invoice 102, corresponding to a product/service category, is within a spend limit pertaining to the product/service category. If a line amount corresponding to a line item in invoice 102 exceeds the spend limit, approval module 216 approves a part or a fraction of the line amount pertaining to the product/service category associated with the line item, provided the product/service category is in compliance with the corresponding product/service category policy. Further, approval module 216, computes an aggregate of the line amounts corresponding to the multiple line items, and if the aggregate line amount exceeds the spend limit, approval module 216 approves a fraction of the spend limit, provided the product/service categories of each of the line items are in compliance with their corresponding product/service category policies.

In some instances, when the line amount for a product/service category has exceeded the spend limit (maximum allowable limit for a transaction), a partial amount (a fraction of the spend limit) may be validated for the transaction based on partial amount transaction thresholds predefined by the client in the rules/policy database.

Further, approval module 216 validates a tax code corresponding to the product/service category and verifies a tax rate corresponding to the tax code charged in invoice 102 by checking the rules/policy database via database module 212. The tax code/rate pertains to at least one of the categories of GST namely, CGST, SGST and IGST.

In some embodiments, approval module 216 checks if invoice 102 is unique to prevent fraud and duplication of invoices. To perform the check, approval module 216 validates parameters such as, but not limited to, invoice number, date of transaction, the invoice transaction amount and whether the invoice is for the same merchant as a previous invoice.

Once approval module 216 validates invoice 102, it sends an approval or confirmation to transaction processing module 218.

Transaction processing module 218 then processes the amount for the transaction in response to receiving the approval for the amount from approval module 216.

In an embodiment, transaction processing module 218 activates and loads a financial instrument with the approved amount. A financial instrument, can be, but need not be limited to, a prepaid card, a credit card, an E-wallet including a virtual card and a mobile wallet, a gift card, a coupon, a loyalty/rebate card and near-field communication (NFC) tags. For example, when a purchase or transaction is made for Merchant X by a consumer, transaction processing module 218 loads a gift card for Merchant X with the approved amount, enabling the user to complete the transaction using the gift card.

In another embodiment, transaction processing module 218 issues a transaction token for the approved amount for completing the transaction using the financial instrument. The transaction token can be, but need not be limited to, a PIN that may change every two minutes for securing the transaction.

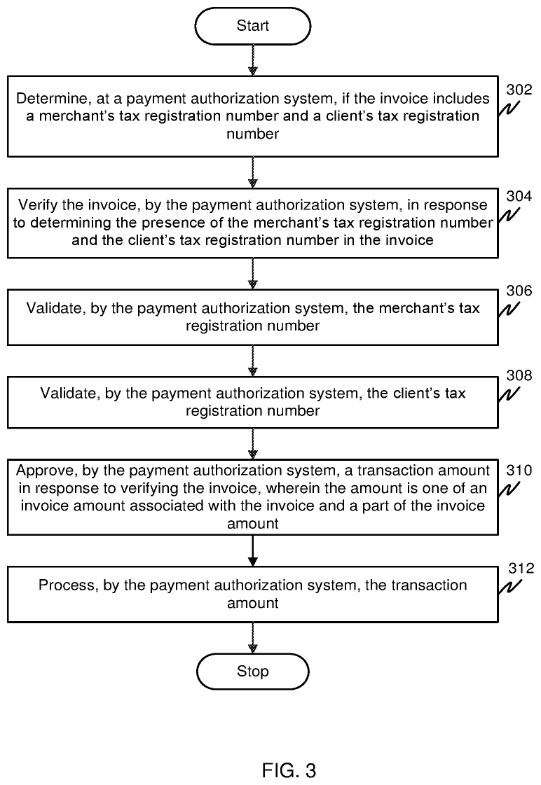

FIG. 3 illustrates a flowchart of a method for performing secure real-time processing of invoice 102 pertaining to a transaction between the merchant and the client in accordance with an embodiment of the invention.

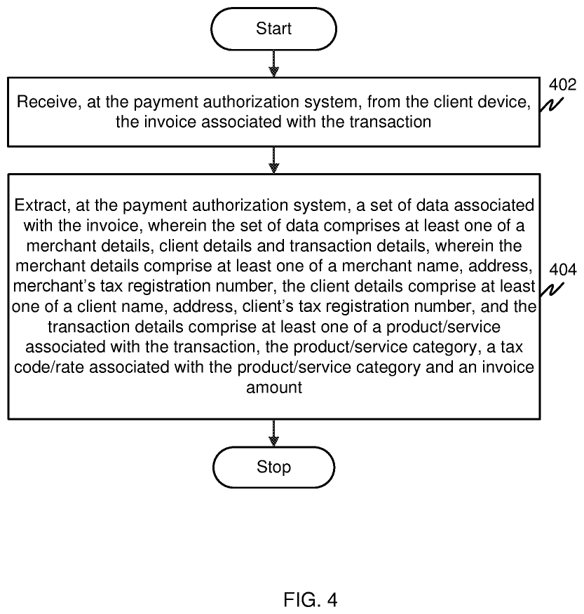

Upon receiving invoice 102, at step 302, invoice validator module 210 of payment authorization system 106 determines if invoice 102 includes the merchant's tax registration number and the client's tax registration number by checking the parameters extracted from invoice 102 by scanning module 208. Step 302 is further described in detail in conjunction with FIG. 4.

Upon determining the presence of the merchant's tax registration number and the client's tax registration number in invoice 102, at step 304, invoice validator module 210 verifies invoice 102 by validating both the merchant's tax registration number and the client's tax registration number in steps 306 and 308 respectively, using database module 212.

Database module 212 is in communication with the Tax Registration Number Database and Rules/Policy Database 214 which includes a tax registration number database and a rules/policy database. The tax registration number database maintains a record of tax registration numbers corresponding to various merchants and clients. On the other hand, the rules/policy database stores a set of validation rules set by clients or users and merchants and government regulations. These include, but need not be limited to, tax rates, exchange rates, country code indicators (that is, the purchaser and seller tax jurisdictions), transaction amount validation thresholds (spending limits based on transaction type), country local currency codes, legal article numbers, and valid reasons for zero VAT.

Invoice validator module 210 validates the merchant's tax registration number and the client's tax registration number by performing a lookup in the tax registration number database.

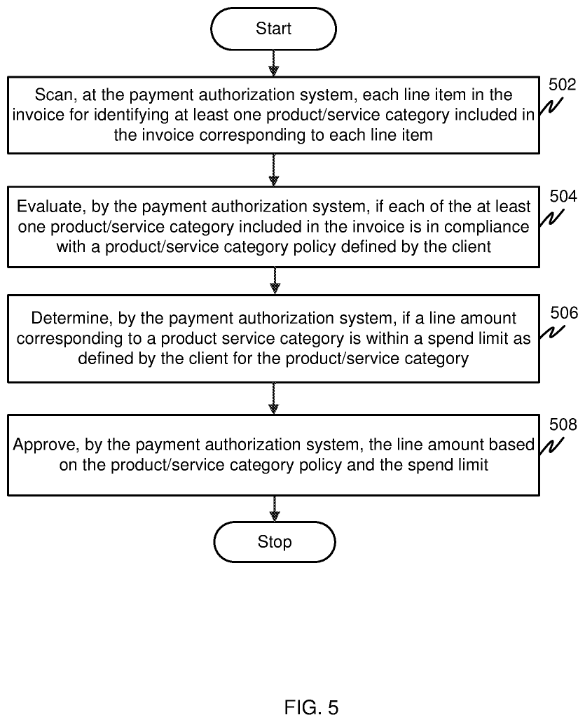

Invoice validator module 210 then communicates the result of the validation to approval module 216. At step 310, approval module 216 approves a transaction amount for the transaction based on the result of the validation. The transaction amount is either an invoice amount associated with invoice 102 or a portion of the invoice amount. The portion of the invoice amount may be determined by preset thresholds/limits that are stored in the rules/policy database. Step 310 is further described in detail in conjunction with FIG. 5.

Subsequently, at step 312, transaction processing module 218 processes the approved transaction amount and completes the transaction.

FIG. 4 illustrates a flowchart of a method for determining if invoice 102 includes the merchant's tax registration number and the client's tax registration number in accordance with an embodiment of the invention.

At step 402, input/output module 206 of payment authorization system 106 receives invoice 102 from client device 104.

Thereafter, at step 404, scanning module 208 of payment authorization system 106 scans invoice 102 and extracts a set of data associated with invoice 102. The set of data includes one or more merchant details, client details and transaction details. The merchant details include a merchant name, address and merchant's tax registration number. The client details include at least one of a client name, address and client's tax registration number, and the transaction details include one or more of a product/service associated with the transaction, the product/service category, a tax code/rate associated with the product/service category and a transaction amount. Scanning module 208 may utilize technologies such as, but not limited to, Optical Machine Readers, Bar Code Readers and Optical Character Recognition (OCR) to scan invoice 102 to extract the set of data from invoice 102.

FIG. 5 illustrates a flowchart of a method for approving a transaction amount for the transaction in response to verifying invoice 102 in accordance with an embodiment of the invention.

In response to verifying invoice 102, at step 502, scanning module 208 of payment authorization system 106, scans each line item in invoice 102 for identifying one or more product/service categories included in invoice 102 corresponding to each line item.

In response to identifying the one or more product/service categories, at step 504, approval module 216 of payment authorization system 106, evaluates if each of the product/service category included in invoice 102 is in compliance with a product/service category policy defined by the client, by performing a lookup in the rules/policy database.

Further, at step 506, approval module 216 determines if a line amount corresponding to a product service category is within a spend limit as defined by the client for the product/service category by checking the rules/policy database.

In response to determining that each of the product/service category included in invoice 102 is in compliance with a product/service category policy defined by the client and that the line amount is within the spend limit, at step 508, approval module 216 approves the line amount for the transaction based on the product/service category, spend limit and partial amount transaction thresholds. If a line amount of a line item corresponding to product/service category policy exceeds the spend limit defined for the product/service category, approval module 216 approves a fraction of the spend limit for the transaction. In the same way, approval module 216 computes an aggregate of the line amounts and approves a fraction of the spend limit defined for the product/service categories if the aggregate line amount exceeds the spend limit.

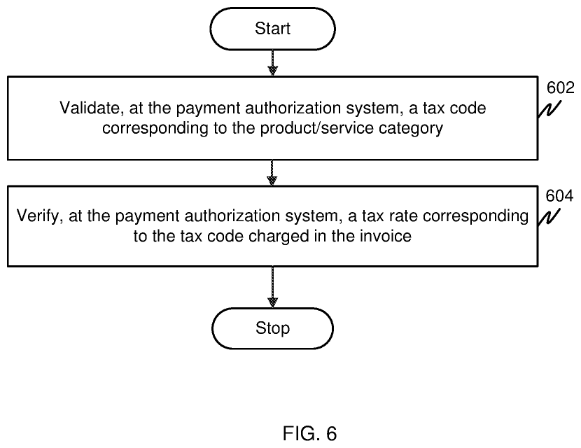

FIG. 6 illustrates a flowchart of a method for approving a transaction amount for the transaction in response to verifying invoice 102 in accordance with another embodiment of the invention.

At step 602, approval module 216 validates a tax code corresponding to the product/service category. Subsequently, at step 604, approval module 216 verifies a tax rate corresponding to the tax code charged in invoice 102 utilizing the rules/policy database. The tax code/rate pertains to at least one of the categories of GST namely, CGST, SGST and IGST.

Once approval module 216 validates invoice 102, approval module 216 approves a transaction amount for the transaction and sends the approval or confirmation to transaction processing module 218. Transaction processing module 218 processes the transaction amount in response to receiving the approval.

In an embodiment, transaction processing module 218 activates and loads a financial instrument with the transaction amount approved by approval module 216. A financial instrument, can be, but need not be limited to, a prepaid card, a credit card, an E-wallet including a virtual card and a mobile wallet, a gift card, a coupon, a loyalty/rebate card and NFC tags.

In another embodiment, transaction processing module 218 issues a transaction token for the transaction amount approved by approval module 216 for completing the transaction using the financial instrument. The transaction token can be, but need not be limited to, a PIN that may change every two minutes for securing the transaction.

The invention authorizes an invoice transaction amount pertaining to a transaction between a merchant and a client to be processed by a payment instrument, only if the merchant tax registration number and the client tax registration number provided in the invoice are matched/mapped to the respective tax registration numbers stored in a database. Thus, the invention provides a secure and faster mechanism for processing payment transactions compared to state of the art payment processing tools and techniques.

Further, the invention provides an efficient means for detecting non-compliance of parameters provided in the invoice by checking them against a rules/policy database. On detecting non-compliance of any one of the parameters, the security mechanism of the invention is immediately triggered, preventing payout at the payment instrument, unless the presence of a valid TAX ID associated with the client or user is detected.

Further, the scanning mechanism of the invention utilizes advanced technologies to parse and extract parameters encoded in the invoice.

Also, the invoice validation mechanism of the invention validates a transaction, considering the merchant data of a payment request which includes tax or merchant registration details (for example, tax number or business number such as a VAT identification number or a registration number) for GST purposes to claim input tax credits.

Thus, the invention provides an automated and secure means for validating and verifying invoices for authorizing payment transactions in real-time, upon receiving an invoice from the merchant or a client or user device.

Those skilled in the art will realize that the above recognized advantages and other advantages described herein are merely exemplary and are not meant to be a complete rendering of all of the advantages of the various embodiments of the invention.

The system, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which can implement the steps that constitute the method of the invention. The computing device includes a processor, a memory, a nonvolatile data storage, a display, and a user interface.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for secure real-time processing of an invoice pertaining to a transaction between a merchant and a client at the time of initiating payment at a point-of-sale terminal, the method comprising:
determining, at a payment authorization system, if the invoice includes a merchant's tax registration number and a client's tax registration number;
verifying the invoice, by the payment authorization system, in response to determining the presence of the merchant's tax registration number and the client's tax registration number in the invoice, wherein the verifying comprises:
validating, by the payment authorization system, the merchant's tax registration number; and
validating, by the payment authorization system, the client's tax registration number;
approving, by the payment authorization system, a transaction amount in response to verifying the invoice, wherein the transaction amount is one of an invoice amount associated with the invoice and a part of the invoice amount; and
processing, by the payment authorization system, the transaction amount.

2. The method of claim 1, wherein the invoice is in the form of one of a hard copy and a digital copy, wherein a digital copy includes one of an image, a word file and a Portable Document format (PDF).

3. The method of claim 1, wherein the determining comprises:
receiving, at the payment authorization system, from the client device, the invoice associated with the transaction; and
extracting, at the payment authorization system, a set of data associated with the invoice, wherein the set of data comprises at least one of a merchant details, client details and transaction details, wherein the merchant details comprise at least one of a merchant name, address, merchant's tax registration number, the client details comprise at least one of a client name, address, client's tax registration number, and the transaction details comprise at least one of a product/service associated with the transaction, the product/service category, a tax code/rate associated with the product/service category and an invoice amount.

4. The method of claim 1, wherein the verifying comprises matching, by the payment authorization system, the merchant's tax registration number and the client's tax registration number with a tax registration number database.

5. The method of claim 1, wherein the approving comprises:
scanning, at the payment authorization system, each line item in the invoice for identifying at least one product/service category corresponding to each line item;
evaluating, by the payment authorization system, if each of the at least one product/service category included in the invoice is in compliance with a product/service category policy defined by the client;
determining, by the payment authorization system, if a line amount corresponding to a product/service category is within a spend limit as defined by the client for the product/service category; and
approving, by the payment authorization system, the line amount based on the product/service category policy corresponding to the product/service category and the spend limit.

6. The method of claim 5 further comprises:
validating, at the payment authorization system, a tax code corresponding to the product/service category; and
verifying, at the payment authorization system, a tax rate corresponding to the tax code charged in the invoice.

7. The method of claim 1, wherein the processing comprises activating a financial instrument for the transaction amount approved by the payment authorization system.

8. The method of claim 1, wherein the processing comprises issuing a transaction token for the transaction amount approved by the payment authorization system for completing the transaction using a financial instrument.

9. The method of claim 1, wherein the processing comprises loading a financial instrument with the transaction amount approved by the payment authorization system.

10. A system for enabling real-time processing of an invoice pertaining to a transaction between a merchant and a client at the time of initiating payment at a point-of-sale terminal, the system comprising:
a memory;
a processor communicatively coupled to the memory;
a security mechanism communicatively coupled to the memory and the processor, wherein the security mechanism is configured to:
determine if the invoice includes a merchant's tax registration number and a client's tax registration number, on initiating the payment at the point-of-sale terminal;
verify the invoice in response to determining the presence of the merchant's tax registration number and the client's tax registration number in the invoice, wherein the verifying comprises:
validating the merchant's tax registration number; and
validating the client's tax registration number;
approve a transaction amount in response to verifying the invoice, wherein the transaction amount is one of an invoice amount associated with the invoice and a part of the invoice amount; and
process the transaction amount.

11. The system of claim 10, wherein the security mechanism is configured to:
receive from the client device the invoice associated with the transaction; and
extract a set of data associated with the invoice, wherein the set of data comprises at least one of a merchant details, client details and transaction details, wherein the merchant details comprise at least one of a merchant name, address, merchant's tax registration number, the client details comprise at least one of a client name, address, client's tax registration number, and the transaction details comprise at least one of a product/service associated with the transaction, the product/service category, a tax code/rate associated with the product/service category and an invoice amount.

12. The system of claim 10, wherein the security mechanism is configured to match the merchant's tax registration number and the client's tax registration number with a tax registration number database.

13. The system of claim 10, wherein the security mechanism is configured to:
scan each line item in the invoice for identifying at least one product/service category included in the invoice corresponding to each line item;
evaluate if each of the at least one product/service category included in the invoice is in compliance with a product/service category policy defined by the client;
determine if a line amount corresponding to a product/service category is within a spend limit as defined by the client for the product/service category; and
approve the transaction amount based on the product/service category policy corresponding to the product/service category and the spend limit.

14. The system of claim 13, wherein the security mechanism is further configured to:
validate a tax code corresponding to the product/service category; and
verify a tax rate corresponding to the tax code charged in the invoice.

15. The system of claim 10, wherein the security mechanism is configured to activate a financial instrument for the transaction amount approved by the payment authorization system.

16. The system of claim 10, wherein the security mechanism is configured to issue a transaction token for the transaction amount approved by the payment authorization system for completing the transaction using a financial instrument.

17. The system of claim 10, wherein the security mechanism is configured to load a financial instrument with the transaction amount approved by the payment authorization system.
